(19) United States
(12) Patent Application Publication
(10) Pub. No.: US 2006/0159801 A1
(43) Pub. Date: Jul. 20, 2006

(54) Use of d-tagatose for improving aroma taste

(76) Inventors: Kurt Rosenplenter, Salzgitter (DE); Katrin Mende, Braunschweig (DE)

Correspondence Address: CANTOR COLBURN, LLP, 55 GRIFFIN ROAD SOUTH, BLOOMFIELD, CT, 06002, US

(21) Appl. No.: 10/545,928

(22) PCT Filed: Feb. 18, 2004
(86) PCT No.: PCT/EP04/01531

§ 371 Date: Aug. 18, 2005

(30) Foreign Application Priority Data
Feb. 20, 2003 (DE) 10307445.7
Jul. 11, 2003 (DE) 10331711.2

(51) Int. Cl. A23G 4/00; A23L 1/22

(52) U.S. Cl. 426/3; 426/534

(57) ABSTRACT

The invention relates to the use of D-tegatose for improving aroma taste and, thereby enhancing the taste sensation for food products, in particular chewing gums, chewing sweeties, pills and similar long-tasting products.

The present invention relates to the use of D-tagatose for enhancing aroma taste. The present invention relates in particular to the use of D-tagatose for enhancing aroma taste in chewing gum, chewable sweets, tabletted confections, and the like.

D-tagatose (hereinafter also referred to as tagatose) is the monosaccharide D-lyxo-2-hexulose. D-tagatose is an isomer of fructose and is obtainable by isomerisation of D-galactose. Its molecular weight is 180.16 g, with a melting point of about 134 to 136° C.

D-tagatose has a relative sweetening effect of 92% with reference to sucrose, but only a low calorie content. Together with its pure, clean, aftertaste-free sweetness, it is therefore eminently suitable as a sweetening agent.

Tagatose is therefore used as a sweetening agent in dietary products. The use of tagatose as an additive in detergents, and in cosmetic and pharmaceutical products is also known.

Tagatose is known to be capable of exerting a synergistic effect on other sweetening agents. For example, WO 99/34689 describes tagatose as being able, even in small proportions, to improve and accentuate the sweet subjective taste both of sweetening agents having a high sweetening capability and of those having a low sweetening capability. It also states that the taste of sweetening agents frequently perceived as unpleasant by consumers may be improved by adding tagatose.

It is therefore proposed to use tagatose to enhance the sweetening effect and subjective taste of sweetening agents in food items and drinks, in particular in dietary food items and drinks and low-calorie food items and drinks.

WO 97/22263 relates to a chewing gum which contains D-tagatose as a sweetening agent. Tagatose is stated as being non-cariogenic and, in contrast with many other sweeteners, to be thought not to cause digestive problems, with the result that tagatose is an advantageous substitute for sweeteners which are known per se. It is also mentioned that the texture and storage stability of chewing gum may be improved with the use of tagatose and that, owing to its slightly reduced sweetening effect by comparison with sucrose, the substance makes new subjective tastes a possibility.

As well as sweeteners, aromas are often added to chewing gums to give them a very wide range of different tastes. Examples of aromas frequently used in chewing gums are peppermint, menthol and cinnamon.

However, the subjective taste imparted by the aromas has been shown to diminish markedly or even to completely disappear after only a short time.

There was therefore a requirement for a possible means of prolonging and/or enhancing the subjective taste of aromas in products such as chewing gum or the like, which remain in the consumer's mouth for fairly long periods of time.

In this regard, in EP 0 784 933 it is proposed to add to edible goods, in particular chewing gums, bubble gums, instant drinks and frozen desserts, additives such as aromas, sweetening agents, and vitamins together with a vehicle which delays the release of the additives and prolongs their effectiveness. It is described, for example, that the subjective taste of the aromas in chewing gums could be prolonged more than twofold by the use of aromas together with the vehicle.

The vehicles used are fine-particulate materials such as, for example, microcrystalline cellulose, zeolites, aluminium silicates, carbon black and mixtures thereof. For use, the respective additives may be mixed with the fine-particulate vehicle and added to the relevant edible product.

Independently thereof, however, there was also a requirement for possible means of intensifying the subjective taste of aromas, especially in products intended to remain in the consumer's mouth for fairly long periods.

Surprisingly, it was found that D-tagatose exerts a synergistic effect on the subjective taste of aromas, with the result that, for the consumer, a stronger and more long-lasting subjective taste is produced.

The present invention thus relates to the use of D-tagatose for enhancing aroma taste.

The present invention may in principle be used for all possible types of edible goods and drinks. However, its advantages come to bear in particular in the case of the kind of edible goods which are intended to remain in the consumer's mouth for fairly long periods, such as chewing gums, chewable sweets, tabletted confections and the like. The invention thus relates in particular to the use of D-tagatose for enhancing aroma taste in chewable goods such as chewing gums.

Within the meaning of the invention, “aromas” are understood as flavourings and flavouring preparations which are intended for the sole purpose of imparting a specific taste to food items other than a purely sweet, acid or salty taste, such as is also described in the German Decree on Essences dated 9 Oct. 1970 in the version of 10 May 1976 (Bundesgesetzblatt I, pages 1200 and 1203).

In principle any D-tagatose such as is commercially available may be used for the present invention. In view of the use in products for human consumption, however, a food-compatible tagatose should be used.

In addition to the advantages already mentioned, such as low calorific value, tagatose has properties of a so-called functional food which are manifested in particular in increased butyrate formation.

Since D-tagatose is metabolised only to reduced degree by Streptococcus mutans in plaque, during its consumption the pH value on the dental surface does not fall below 5.7. D-tagatose can therefore be regarded as non-cariogenic.

With regard to its use in the diet of diabetics, studies at the University of Maryland have shown that oral ingestion of 75 g of tagatose per day does not bring about an increase in the glycaemic index.

A preferred use according to the invention relates to the use of D-tagatose in chewable goods such as chewing gum etc.

Chewing gum is a chewable substance consisting of a gum base, which is virtually indigestible for humans, at least one sweetening agent selected as required from sugars, sugar substitutes and sweeteners and mixtures thereof, as well as aromas for imparting taste.

Subjective sweetness during consumption depends mainly on the dissolution rate of the sweetening agents used and on the homogenous incorporation of the sweetening agents in the insoluble gum base.

Since chewing gum is to have a smooth consistency, finely crystalline sweetening agents having a particle size of<100 μm, in particular<63 μm, are normally used. However, use in this finely-crystalline form increases the solubility of the sweetening agent, with the result that the subjective sweetness as a function of the masticated chewing-gum volume decrease is relatively quickly, for example in less than 5 minutes. In order to prolong the subjective sweetness, additional processing steps such as encapsulation of the sweetening agent are therefore necessary.

Owing to the property of D-tagatose of mediating an increase in and longer persistence of the subjective sweetness by comparison with sucrose and other sweetening agents, even during normal consumption, D-tagatose is eminently suitable for use as a sweetening agent in chewing-gum products. In combination with the synergistic effect of tagatose on aromas, found according to the invention, and the thereby achieved long-persisting aroma stability and prolonged perception of sweetness, a substantial improvement in the chewing-gum quality can be achieved.

In respect of the technology, a further advantage is seen in the fact that no further processing steps such as vehicles or encapsulation of sweetening agents or aromatic substances, which are intended to delay release and thus to mediate a longer-persisting subjective taste, are necessary for achieving the long-persisting aroma stability and subjective sweetness.

For the present invention, the tagatose may be used in any form, which may be selected in accordance with requirements.

Thus, the tagatose may be added as a solid or a syrup with a suitable solvent such as water.

In principle there also exists the possibility of using the tagatose, in accordance with requirements, either alone or together with other additives, in any way which is known per se, e.g. as a co-crystallisate, a co-precipitate, in encapsulated form, as an agglomerate or adsorbed on to other additives, etc.

The techniques and necessary means for doing this have been described many times and are generally known in the art.

D-tagatose may be used as a single sweetening agent or together with other sweetening agents or sweeteners, for example low-calorie sweeteners, sugar substitutes, for example for dietary products, and sugars.

Suitable examples of sugars are sucrose, and also dextrose, of sugar substitutes sorbitol, xylitol, maltitol, mannitol, isomalt, erythritol and lactitol, and of sweeteners saccharine, cyclamate, acesulfam K, aspartame, neohespiridine, thaumatine or sucralose, and mixtures thereof.

In the case of sugar-free chewing gums, the sometimes deficient sweetness as compared with a gum sweetened with sucrose may be compensated for by adding one or more sweeteners, some of which are mentioned above.

In the case of sugar-containing chewing gums, sweeteners may be added to achieve specific subjective tastes.

In principle any gum base may be used; these are known and have been described many times for the production of chewing gums. Examples are elastomeric materials such as synthetic or natural rubbers and elastomers such as polyisobutylene, isobutylene-isoprene copolymer, and butadiene-styrene copolymer.

The gum base may also contain softeners, plastifiers and emulsifiers. For example, to increase the plasticity as a liquid phase, glycerine and glucose syrup or a sorbitol or maltitol syrup may be used.

Regarding the aromas, any natural, nature-identical and synthetic aromas may be used; these are conventional and are known. Examples are ethereal oils, vegetable oils, fruit aromas such as fruit oils, as well as fruit essences such as mint, peppermint, menthol, spearmint, wintergreen, oil of lemon, cinnamon, aniseed, oil of cloves, etc. Especially preferred are mint, peppermint, menthol, spearmint, wintergreen, cinnamon, fruit aromas and combinations thereof. In the case of fruit aromas, palatable acids may also be added as required.

The chewing gum may, if required, contain further additives and excipients conventional and known for chewing gums, such as thickening agents, fillers, texturing agents, antioxidants, preservatives and colouring agents.

These are generally known and, for example, are also described in the aforementioned patent applications.

The manufacture of chewing gum is similarly known per se and has been described many times in the literature, reference once again being made, by way of example, to the aforementioned patent applications.

For manufacture, the ingredients of the chewing gum are combined in an intensive mixing process.

Intensive mixing is necessary in order to achieve a homogenous distribution of the taste-imparting constituents, such as aromas and sweetening agents, in order that the subjective taste persists for as long as possible during chewing.

In order to further promote a long-persisting aroma stability, it is also possible to maintain the subjective taste over a lengthy period by encapsulating the aromas and by combining the dose-metering of liquid and solid aromas.

To achieve the effect according to the invention, tagatose may be contained in the chewing gum in a content of 0.1 wt. % to 50 wt. %, preferably from 0.1 wt. % to 30 wt. %, and in particular 0.1 to 10 wt. %, with reference to the total mass.

An example of a suitable composition of a chewing gum with the use of tagatose according to the invention to enhance aromas comprises 5 to 50 wt. % of gum base, 0 to 90 wt. % of sweetening agent, wherein 1 to 50 wt. % of the sweetening agent is D-tagatose, aroma or a combination of different aromas>0 to 5 wt. %, and optionally 0 to 5 wt. % of emulsifier and 0 to 10 wt. % of glycerine.

The tagatose may also be the only sweetening agent.

If tagatose and/or the sweetening agent are used in a crystalline form, the particle size should be<315 μm.

A further preferred aspect of the present invention relates to the use of D-tagatose to enhance the taste of aromas in tabletted confections.

Tabletted confections are understood as a group of tablet-shaped sweet goods based on sugars and/or sugar substitutes (polyols), which are conventionally produced by compression (tabletting).

The tabletted confections contain aromas, for example those mentioned above.

They may also contain tabletting aids such as magnesium or calcium stearate, and optionally other, conventional and generally known, additives.

Pressing may be carried out either directly, i.e. with the use of finely-crystalline raw materials, or following prior agglomeration of the raw materials.

A description of the manufacture of tabletted confections and of additives usable therefor may be found in Sugar Confectionery Manufacture, 2^{nd} edition, E. B. Jackson, Chapman & Hall, 1995, to which reference is expressly made here.

A crucial quality criterion for tabletted confections is the external appearance of the tablet body. The consumer anticipates a solid, smooth product which is pleasant to suck. D-tagatose is eminently miscible with other sugars and sugar substitutes, the mixtures being directly compressible to form solid and readily suckable tablets.

In principle, the aforementioned sugars and/or sugar substitutes may be used for this purpose. However, those especially preferred are sorbitol, xylitol, isomalt, polydextrose and erythritol and mixtures thereof, in particular sorbitol/xylitol and sorbitol/isomalt/xylitol.

According to the invention, D-tagatose may be added to the tabletted confections in the same weight ratios mentioned above for chewing gum.

It has been shown that the subjective taste of the aromas is enhanced by comparison with their use in conventional tabletted confections, without the occurrence of over-expression or of an over-intense sweetness which is perceived as unpleasant.

A proportion of D-tagatose of 0.1 to 10 wt. % has proved especially advantageous for this purpose.

By this means it was possible to achieve an especially long-lasting subjective taste in particular for aromas such as peppermint, menthol, spearmint, wintergreen and cinnamon.

By the addition of tagatose, the subjective taste of aromas may be enhanced in food items in which a long-lasting taste is especially desirable, such as in chewing gums and tabletted confections.

1. A method of using D-tagatose for enhancing aroma taste in food items and drinks.

2. A method of using D-tagatose according to claim 1, for enhancing aroma taste in chewing gums.

3. A method of using D-tagatose according to claim 1, for enhancing aroma taste in tabletted confections.

4. A method of using D-tagatose according to claim 1, wherein the tagatose is contained in a proportion of 0.1 to 50 wt. %, in particular 0.1 to 30 wt. %, with reference to the total mass.

5. A method of using D-tagatose according to claim 1, wherein the aroma at least one selected from mint, peppermint, menthol, spearmint, wintergreen, cinnamon and fruit aroma.

6. A method of using D-tagatose according to claim 1, wherein the D-tagatose is used in combination with sweetening agents.

7. A method of using D-tagatose according to claim 1, wherein the D-tagatose is added to a chewing gum which additionally contains at least one aroma selected from mint, peppermint, menthol, spearmint, wintergreen, cinnamon and fruit aroma and optionally contains at least one further sweetening agent.

8. A method of using D-tagatose according to claim 1, wherein the D-tagatose is added to a tabletted confection which contains at least one aroma selected from mint, peppermint, menthol, spearmint, wintergreen, cinnamon and fruit aroma and optionally at least one further sweetening agent.
